(19) United States
(12) Patent Application Publication
(10) Pub. No.: US 2018/0246880 A1
(43) Pub. Date: Aug. 30, 2018

(54) SYSTEM FOR GENERATING SYNTHETIC SENTIMENT USING MULTIPLE POINTS OF REFERENCE WITHIN A HIERARCHICAL HEAD NOUN STRUCTURE

(71) Applicant: NASDAQ, INC., New York, NY (US)

(72) Inventor: Keith WOODS-HOLDER, Saltdean (GB)

(21) Appl. No.: 15/969,132

(22) Filed: May 2, 2018

Related U.S. Application Data
(63) Continuation of application No. 13/465,287, filed on May 7, 2012, now abandoned.

(51) Int. Cl. G06F 17/27

(52) U.S. Cl. CPC G06F 17/2785; G06F 17/271

(57) ABSTRACT

A system is presented that provides sentiment analysis technology that takes into account the perspective or context of the individual or entity for which the sentiment analysis is being performed. Using multiple points of reference within a hierarchical head noun structure (containing head nouns of root terms and possibly dependent terms), the structure allows the system to return different outcomes depending on a user query specifying one or more head nouns to be taken as reference points for sentiment calculations. As a result, an appropriate context for sentiment analysis is determined which takes into account the perspective/context associated with the individual or entity for which the analysis is performed.

### RELATED APPLICATIONS

This application is a continuation of U.S. patent application Ser. No. 13/465,287 filed May 7, 2012.

### BACKGROUND

Sentiment analysis technology allows automated systems the ability to analyze input data (including text, text symbols (e.g., emoticons), and or contracted speech terms used in text messaging) to determine a particular sentiment. For example, a user on a social networking web-site may post a comment such as “I like my Apple iPhone.” Sentiment analysis technology can thus determine, based on the structure of the sentence and various keywords in the sentence, the overall sentiment of the statement.

In this instance, the phrase “I like my Apple iPhone” could be considered a generally positive sentiment about the Apple iPhone as well as a positive statement about both Apple, Inc. (the company) and it's product (i.e., the iPhone). When processing multiple posts from various different social media platforms, sentiment can be collected and analyzed for a particular person, corporation, product, or service (amongst many other categories such as opinion, intent, topic, and/or event). Thus, in this example, a corporation such as Apple, Inc. may utilize sentiment analysis services to determine how consumers feel about their company, its products, and/or its services.

However, present sentiment technology does not take into account the perspective or context of the individual or entity in which the analysis is being performed. That is, the phrase “I like my Apple iPhone,” while generally positive to Apple, Inc., could be a generally negative sentiment to a competitor, such as Google, Inc. Thus, there is a need for sentiment analysis technology that properly considers the context of the entity or individual for which the sentiment analysis is being performed.

### BRIEF SUMMARY OF THE TECHNOLOGY

In everyday experience, people typically combine three distinct processes in determining what something “means” and whether there are any associated positive, negative, or other expressions. The technology described in this application uses these three distinct processes to make sentiment analysis adaptable enough to be used in different contexts and for different analysis styles. First, sentiment is the determination of a value with respect to an individual phrase, sentence, or text snippet. The value is useful with this framework. Second, tonality is an aggregated score of sentiments with a complete text sample (e.g., an article, blog, etc.). Third, bias is a modifying override which can be applied to any topic of keyword/phrase to produce a definite outcome irrespective of the sentiment scoring. The combination of these allows automated sentiment to be “tuned,” using a hierarchical set of values stored in a system such as a computer relational database, to a particular organization's or individuals' requirements so that the results make sense to them in their proper context.

A system is presented that provides sentiment analysis technology that takes into account the perspective or context of the individual or entity for which the sentiment analysis is being performed. Using multiple points of reference within a hierarchical head noun structure (containing head nouns of root terms and possibly dependent terms), the structure allows the system to return different outcomes depending on a user query specifying one or more head nouns to be taken as reference points for sentiment calculations. As a result, an appropriate context for sentiment analysis is determined which takes into account the perspective/context associated with the individual or entity for which the analysis is performed.

A method for determining a resultant sentiment value based on a context set and an initial sentiment set is presented. The method is implemented using a sentiment analysis apparatus having one or more processors and the method comprises receiving one or more expressions for sentiment analysis, assigning an initial sentiment value to the one or more expressions based on a predetermined set of language processing rules and creating an initial sentiment set having the one or more expressions and their associated initial sentiment value, creating a context set of head nouns formed as a hierarchical structure, comparing the context set of head nouns to the initial sentiment set to determine matches between the head nouns and the one or more expressions in the initial sentiment set, scoring, using the one or more processors, matches in the initial sentiment set based on an application of the head noun structure to the one or more expressions in the initial sentiment set, creating a resultant sentiment set containing matched expressions and the score associated with the expressions based on the application of the context set to the initial sentiment set, and generating a resultant sentiment value for providing a description of an overall sentiment based on the context in which the one or more expressions are analyzed.

A non-transitory computer-readable storage medium having computer readable code embodied therein which, when executed by a computer having one or more processors, performs the method for determining the resultant sentiment according to the preceding paragraph.

The technology also relates to a sentiment analysis apparatus comprising a memory configured to store character data having one or more expressions and one or more processors coupled to the memory and configured to determine a resultant sentiment value based on a context set and an initial sentiment set. The one or more processors are further configured to receive one or more expressions for sentiment analysis, assign an initial sentiment value to the one or more expressions based on a predetermined set of language processing rules and creating an initial sentiment set having the one or more expressions and their associated initial sentiment value, create a context set of head nouns formed as a hierarchical structure, compare the context set of head nouns to the initial sentiment set to determine matches between the head nouns and the one or more expressions in the initial sentiment set, score, using the one or more processors, matches in the initial sentiment set based on an application of the head noun structure to the one or more expressions in the initial sentiment set, create a resultant sentiment set containing matched expressions and the score associated with the expressions based on the application of the context set to the initial sentiment set, and generate a resultant sentiment value for providing a description of an overall sentiment based on the context in which the one or more expressions are analyzed.

The technology also relates to a sentiment analysis system, comprising an input device configured to input character data having one or more expressions, and a sentiment analysis apparatus coupled to the input device. The sentiment analysis apparatus has a memory configured to store character data input from the input device, and one or more processors coupled to the memory and configured to determine a resultant sentiment value based on a context set and an initial sentiment set. The one or more processors in the apparatus are further configured to receive one or more expressions for sentiment analysis, assign an initial sentiment value to the one or more expressions based on a predetermined set of language processing rules and creating an initial sentiment set having the one or more expressions and their associated initial sentiment value, create a context set of head nouns formed as a hierarchical structure, compare the context set of head nouns to the initial sentiment set to determine matches between the head nouns and the one or more expressions in the initial sentiment set, score, using the one or more processors, matches in the initial sentiment set based on an application of the head noun structure to the one or more expressions in the initial sentiment set, create a resultant sentiment set containing matched expressions and the score associated with the expressions based on the application of the context set to the initial sentiment set, and generate a resultant sentiment value for providing a description of an overall sentiment based on the context in which the one or more expressions are analyzed.

In a non-limiting, example implementation the method further comprises assigning a numerical head noun value associated with each head noun in the head noun structure, assigning a numerical sentiment value associated with the initial sentiment value assigned to each word in the initial sentiment set, matching each head noun in the head noun structure with one or more expressions in the initial sentiment set, mathematically combining (using established mechanisms described as Euler sets) the numerical head noun value with the numerical sentiment value when the head noun matches the expression in the initial sentiment set, and generating the resultant sentiment value of the initial sentiment set based on one or more mathematically combined head noun values.

In yet another non-limiting, example implementation the method further comprises aggregating each result of the mathematical combination of the numerical head noun value with the numerical sentiment value into an aggregated sentiment value, generating the resultant sentiment value based on the aggregated sentiment value, and generating a table of results which may be used to generate a report for display on a user interface device reporting the resultant sentiment.

In another non-limiting, example implementation the numerical head noun value is mathematically combined with the numerical sentiment value by adding the numerical head noun value to the numerical sentiment value when the head noun matches the expression in the initial sentiment set.

In yet another non-limiting, example implementation the numerical head noun value is mathematically combined with the numerical sentiment value by multiplying the numerical head noun value to the numerical sentiment value when the head noun matches the expression in the initial sentiment set.

In another non-limiting, example implementation the sentiment expression comprises at least one of a negative sentiment, a neutral sentiment, a positive sentiment, a factual sentiment, or a null sentiment.

In yet another non-limiting, example implementation the resultant sentiment value comprises at least one of a strong negative sentiment, a negative sentiment, a neutral sentiment, a positive sentiment, or a strong positive sentiment.

### BRIEF DESCRIPTION OF THE DRAWINGS

FIG. 1 is a block diagram of a sentiment analysis system;

FIG. 2 is a block diagram of a sentiment analysis apparatus;

FIG. 3 shows a block diagram of a sentiment analyzer in a sentiment analysis apparatus;

FIG. 4 shows an example application flowchart of a synthetic sentiment process;

FIG. 5 shows an example data structure for a head noun structure;

FIG. 6 shows an example application flowchart for determining a resultant sentiment value; and

FIG. 7 is an example application flowchart for further processes related to mathematically determining the resultant sentiment value.

### DETAILED DESCRIPTION OF THE TECHNOLOGY

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions. Although databases may be depicted as tables below, other formats (including relational databases, object-based models and/or distributed databases) may be used to store and manipulate data. Also, any reference to the term “non-transitory” is intended only to exclude subject matter of a transitory signal per se. The term “non-transitory” is not intended to exclude computer readable media such as volatile memory (e.g. random access memory or RAM) or other forms of storage that are not excluded subject matter.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. The apparatus that performs the process may include, e.g., a processor and those input devices and output devices that are appropriate to perform the process.

Various forms of computer readable media may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

The technology described herein is directed to a sentiment analysis system that automatically analyzes sentiment taking into account the context in which the sentiment should be analyzed. Sentiment analysis systems that require specific user input tailoring and normally serve only one context outcome only, require a large amount of user intervention and maintenance to create contextual models for a sentiment analyzer to work. As a result, this frequently means that these sentiment analysis systems take too long to develop to be of use in anything other than a single context case.

The technology described is implemented in an example embodiment using two mathematical (Euler-type) sets of functions to map words and phrases according to defined sets. It should be appreciate that a Euler set can be defined as a set having the property that each member of a source, such as a potential sentiment, must contain a value or NULL such that there is a corresponding equivalent one-to-one mapping with any destination set(s). Also, NULLs can be renormalized out of the destination set(s) and all values in a destination set(s) can have a corresponding value in the source set.

A first sentiment set allocates values which indicate if a sentiment expression is possible (or implied) by the text structure. A second context set allocates the context (or contexts) which are available to the technology to determine the resultant sentiment. It can also be implied that within Euler sets, the application of a second set to an initial set will achieve a one-to-one mapping between the sets after NULLs have been renormalized. An advantage to using Euler sets is that every calculation which has a valid value in the initial set will have a corresponding value in the destination set (NULL values are discarded) in such a way that the results can be queried for new relationships without having to recalculate the values. Thus, the validity of the results structure will be maintained.

A “parts-of-speech” (POS) tagger is initially used to identify words and groups of words which match a computer-defined set of rules for detecting the existence of a “potential” sentiment expression. That is, the POS tagger identifies the existence of sentiment without viewpoint, which, for a particular viewpoint, can be expressed as positive, negative, neutral, factual, or NULL. These values can also be assigned numerical values. For example, a positive statement can be a positive integer +n, a negative statement can be a negative integer −n, a neutral statement can be some value close to 0 (e.g., 0.02n), a factual statement can be 99n, and a null statement can be 0.

Because the POS tagger does not provide the resultant, viewpoint based sentiment, a context set is implemented to help obtain the resultant sentiment. The context set contains a hierarchical structure, described as a Head Noun Structure (HNS), to resolve the value-to-sentiment of each of the members of the initial sentiment set by applying a fixed point of reference (a head noun) which defines how the initial sentiment elements are to be calculated to give a resultant set (output set) which contains all the sentiment values calculated with respect to each head noun contained within the inputted data.

In each case the value of the head noun can have a positive integer value (e.g., 1 but others are possible) which is modified by the assigned values from the sentiment set by arithmetic operations, such as addition or multiplication. The numerical outcome of applying the HNS to the initial sentiment set elements resolves each ‘potential’ value to a real, non-integer value which can range from a negative number (indicating negative sentiment), 0 (indicating a neutral sentiment), or positive (indicating a positive or favorable sentiment). Likewise, a non-integer value, such as a floating point decimal value can be indicated by the sentiment value (e.g., 0.38238). The technology thus allows for the expression of more than three values as possible expressions in a metric series. So, for example, the resultant sentiment can be described as “very positive,” “positive,” “neutral,” “negative,” and “very negative” thus expanding the initial three value series to five. Of course, other ranges for describing the overall sentiment can be expressed, and this set is not limited to three, five, etc. Also, members of the sentiment set which do not have a corresponding match with the HNS are scored as NULL.

The technology allows the creation of multiple points of reference within the HNS, which in turn allows the system to return different outcomes depending on a user query specifying one or more head nouns to be taken as reference points for sentiment calculations. By creating these points of reference, perspective or context can be treated as a variable and not a fixed value, which in turn allows information to be presented with a higher degree of accuracy for any specific query a user makes to the system.

Accordingly, the context-based technology automates sentiment analysis and provides for more “relevant” sentiment analysis for end users. Also, the technology allows for dynamic automated sentiment analysis that is adaptable to change in language use and/or in end user requirements. Moreover, metrics other than sentiment may be developed from the technology (e.g., detection of events, statistical prediction of outcomes from incomplete sets, incorporation of non-words, slang terms, and colloquialism).

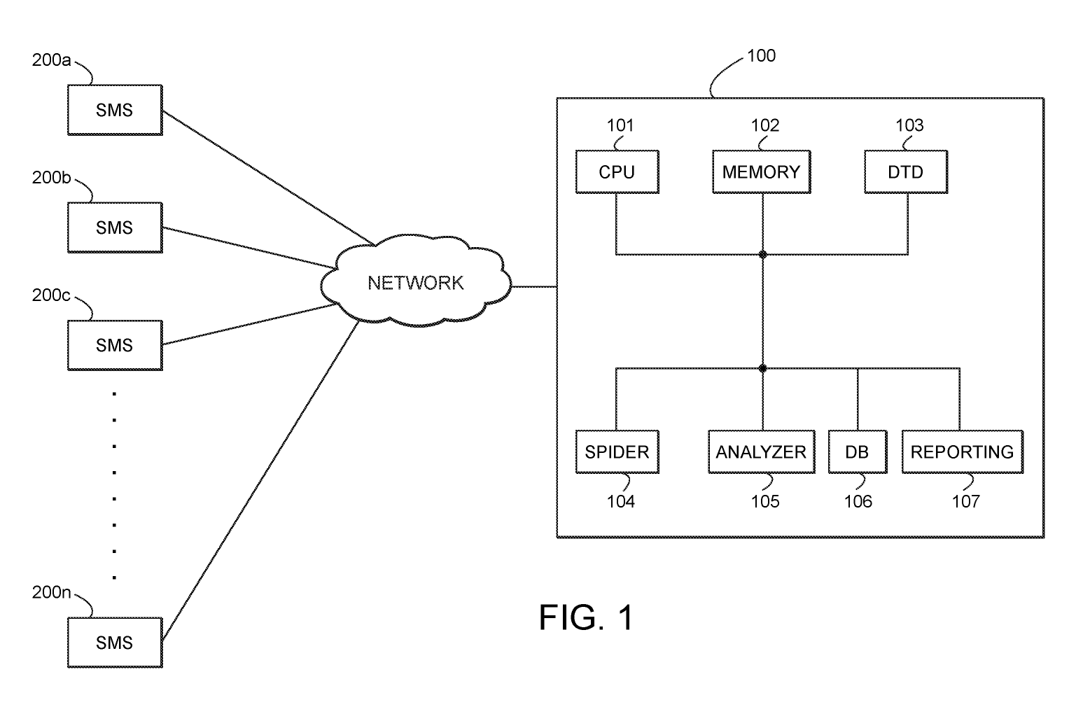

FIG. 1 shows a sentiment analysis system having a sentiment analysis apparatus 100 that interacts with one or more social media sources 200a-n. In FIG. 1, a sentiment analysis apparatus 100 can be configured to have a CPU 101, a memory 102, and a data transmission device DTD 103. The DTD 103 can be, for example, a network interface device that can connect the sentiment analysis apparatus 100 to one or more social media sources 200a-n. The connection can be wired, optical, or wireless and can connect over a Wi-Fi network, the Internet, or a cellular data service, for example. The DTD 103 can also be an input/output device that allows the apparatus 100 to place the data on a computer-readable storage medium. It should be appreciated that the data transmission device 103 is capable of sending and receiving data (i.e. a transceiver).

The apparatus 100 is also configured to have one or more spiders 104, analyzers 105, sentiment databases DB 106, and a reporting unit 107. The spiders 104 can be configured to trawl the various social media sources 200a-n in order to obtain information from the sources 200a-n. The spiders 104 can access information from the sources 200a-n via a network, such as the Internet, and can be configured to access the sources 200a-n using the DTD 103. It should be appreciated that the term “trawl” can generally refer to accessing/sifting through large volumes of data, archives, and/or looking for something of interest.

The analyzer 105 analyzes the received data for sentiment and can store the analyzed data into one or more databases 106. It should be appreciated that the analyzer 105 can also analyze data from the databases 106 for the purposes of analyzing already gathered and stored data. The reporting unit 107 provides a reporting interface for reporting the results of the context related sentiment analysis.

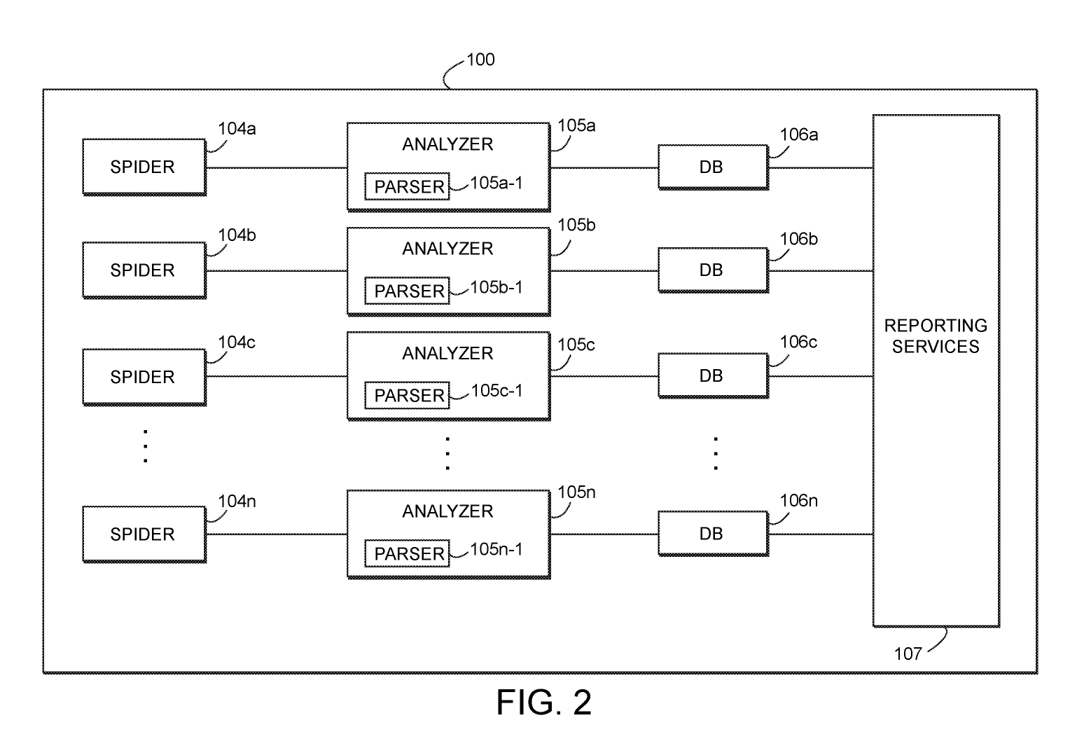

FIG. 2 shows a more detailed view of the sentiment analysis apparatus 100 processing data between the spiders 104, analyzers 105, and databases 106 where it is ultimately reported using the reporting unit 107. As can be seen in FIG. 2, one or more spiders 104a-n retrieve data from one or more social media sources 200a-n (not shown) where the spiders then can pass data off to one or more analyzers 105a-n. The one or more analyzers 105a-n can be configured to each have parsers 105a-1-105n-1. Parsers 105a-1-105n-1 are capable of parsing input data from the spiders 104a-n so that the analyzers 105a-n can analyze the input data for sentiment. After the data has been analyzed by analyzers 105a-n, the data can be stored in one or more databases 106a-n. From there, a reporting unit 107 can retrieve the stored sentiment data for sentiment analysis. It should be appreciated that the analyzers 105a-n may also retrieve data stored in databases 106a-n for initial and/or further analysis. In other words, the system is not limited to only analyzing data retrieved from spiders 104a-n.

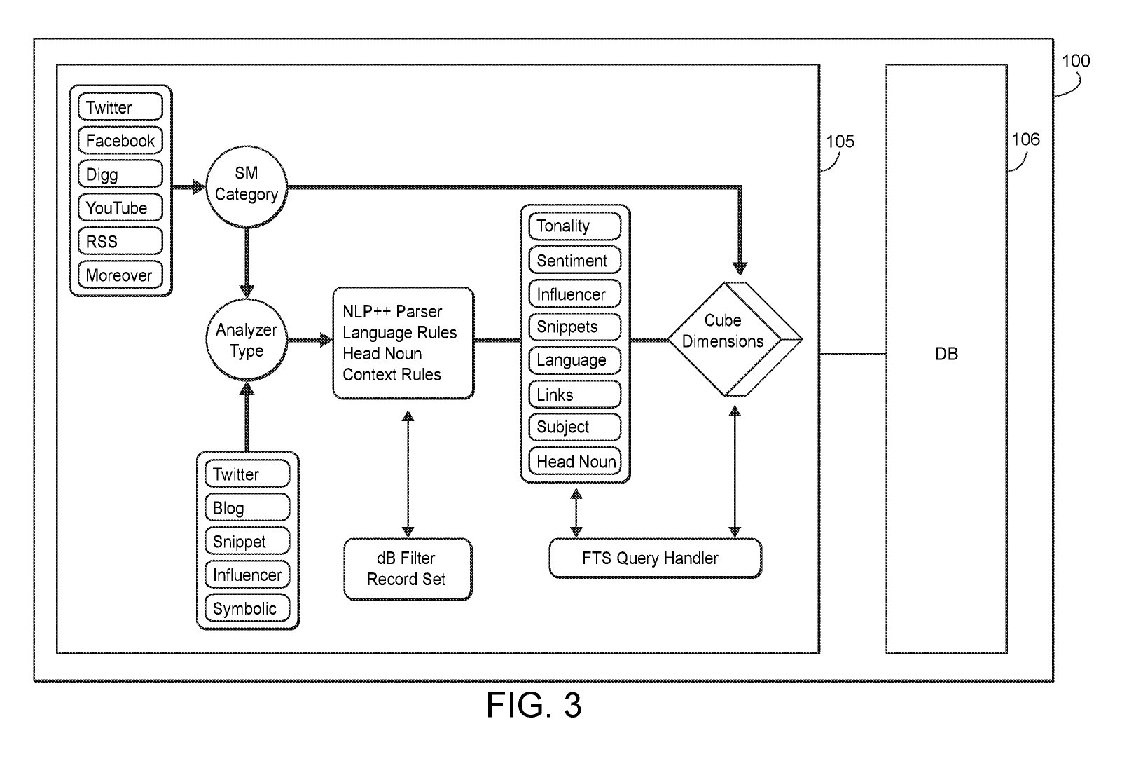

FIG. 3 shows a more detailed view of the analyzers 105a-n interacting with one or more databases 106a-n. For purposes of example only, FIG. 3 shows only one analyzer 105 interacting with one database 106, but as discussed with respect to FIG. 2, one or more analyzers 105a-n and one or more databases 106a-n can be provided.

In FIG. 3, upon receiving data from a social media source 200a-n, the analyzer can first determine the social media category (SM category) of the source. For example, a Facebook® post would fall under the category Facebook® where a YouTube® video would fall under the category YouTube®. An analyzer type can then be determined based on the particular SM category. For example, a user post from Twitter® that is being analyzed may be classified as a Tweet® under the analyzer type. Those skilled in the art should appreciate that different SM categories may need different analyzer types based on the nature of communication in that category. For example, it is common for various symbols to have a particular meaning when using a social media source/platform such as Twitter®. That is, symbols such as “@” and “#” have a significance when used on Twitter® where they may be less significant on another platform, such as a blog.

After the SM category and analyzer types have been established, a natural language parser and language rules can be used to parse the incoming data. Head noun structures and context rules can be defined for applying the head noun structure against the data. As explained in more detail below, the application of the head noun structure to an initial sentiment set helps define an overall context set (e.g., a resultant sentiment set) which provides a resultant sentiment (typically expressed as a value) based on the given context of the sentiment analysis. The initial sentiment set from the different analyzers can be stored as values and “dimensions” in a database as a multi-dimensional array, termed “cube dimensions.” One of skill in the art would understand that cube dimensions allow that subsets and selections of data may be easily isolated and manipulated using database filters (dB Filter Record Set) (a filter being a limiting term or criteria applied to exclude unwanted data). This includes a database filtering system called full text search (FTS Query Handler) that is applied using a specialized “handler” and allows for inflectional terms and time-lined dependencies to be automatically processed without having to be defined by a user.

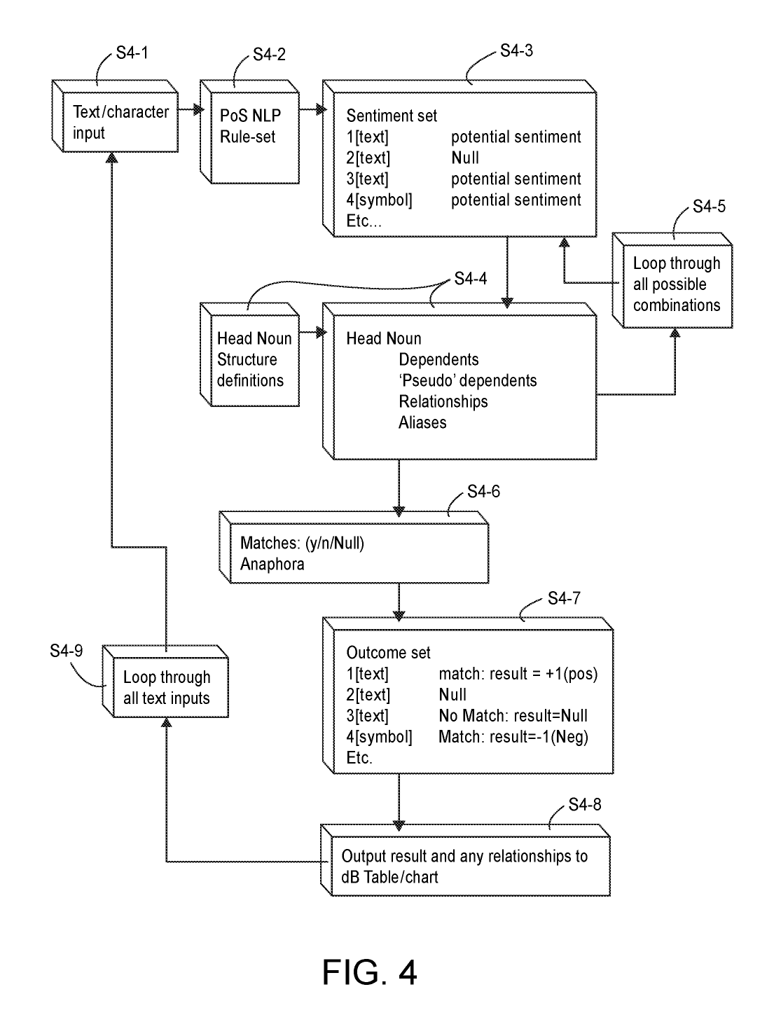

FIG. 4 shows an example application flowchart for a synthetic sentiment process. The process begins by receiving text and/or character input (S4-1) which is processed by a POS tagger that uses a natural language processing rule set (S4-2). After processing by the POS tagger, an initial sentiment set is created (S4-3). In the example shown in FIG. 4, the sentiment set contains data pertaining to both text and character/symbol data where potential sentiment is assigned to some elements where other elements have not been assigned a potential sentiment (e.g., NULL).

After the initial sentiment set has been established, a head noun structure (using head noun structure definitions) is applied against the elements in the initial sentiment set (S4-4) where this processes is repeated for all elements until the set is empty (S4-5). The head noun structure can be applied against the initial sentiment set using arithmetical operations such as addition and/or multiplication.

For example, if the initial sentiment set contains expressions in the phrase “I really love my new Apple iPhone :)” the initial sentiment set may associate a potentially positive sentiment to the phrase, and thus, a value such as +1 may be associated with the phrase. If the head noun structure contains terms related to Apple, Inc., the head noun structure may associate a positive number (e.g., +1) for potentially positive sentiment about Apple and/or its products. Here, the value of the potentially positive sentiment (+1) is multiplied against the value in the head noun structure associating positive sentiment with Apple (+1) thus producing a positive value (+1). Likewise, if the head noun structure contains terms related to a competitor, such as Sony®, the head noun structure may associate positive phrases related to Apple with a negative value (e.g., −1). So in this case, the phrase “I really love my new Apple iPhone :)” will have a positive potential sentiment (+1) multiplied with a value in the head noun structure associating a negative viewpoint of positive potential sentiment for Apple (−1) thus producing a negative value (−1). In this manner, the system can automatically determine the context of a particular sentiment in which it is applied to an entity and/or individual.

As mentioned above, the system determines matches between all possible combinations of the head nouns in the head noun structure and the elements in the sentiment set (S4-6) to produce an outcome set (S4-7) containing a resultant sentiment set given the context provided in the head noun structure. Thus, the potential sentiment derived in the initial sentiment set may now have a different value/weight in view of the elements in the head noun structure. These values can be aggregated to provide a resultant sentiment (output sentiment) given an overall sentiment of an item, such as a product, service, entity, or individual (S4-8). The data can be represented using a user interface and results can be stored in a sentiment database. This process is repeated through all of the text/character input (S4-9).

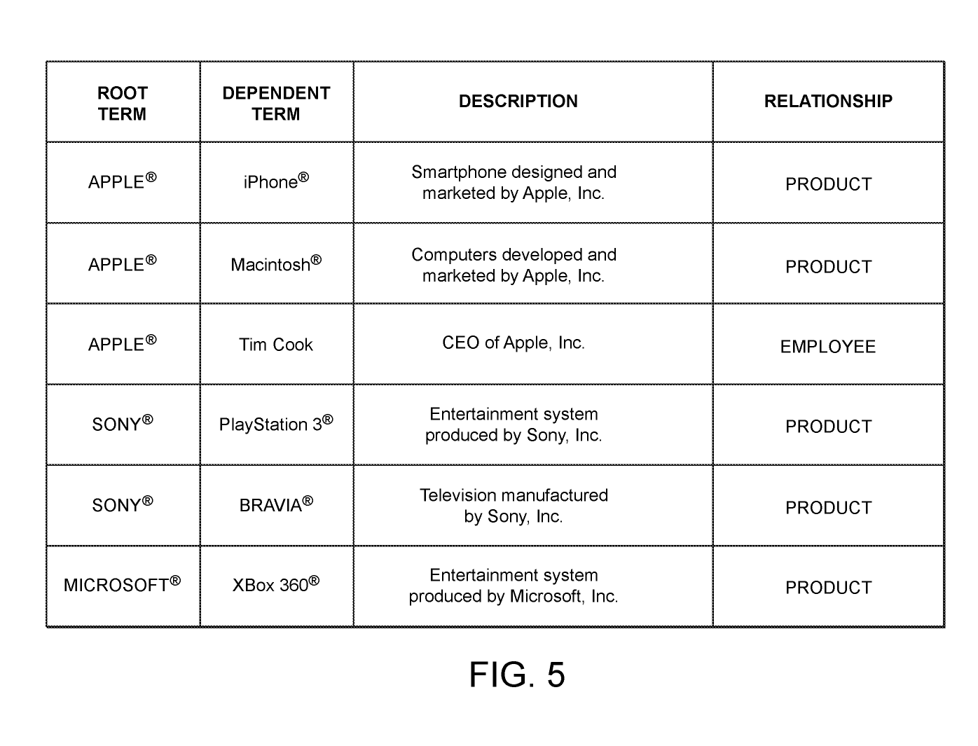

FIG. 5 shows an example table-based, hierarchical head noun structure containing root terms, dependent terms, a description of the terms, and a relationship of the terms. In the example shown in FIG. 5, a head noun structure may contain the term Apple® where Apple® may have several dependent terms associated with it, such as iPhone®, Macintosh®, or Tim Cook. These terms may also have an associated description that describes the nature of the term and its relationship to the root term. For example, the term iPhone® is related to Apple® as a product where the term Tim Cook is related to Apple® as an employee. As explained above, the head noun structure can also be configured to have numerical values associated with different root terms and/or dependent terms. These numerical values can be used when the head noun structure is applied against the initial sentiment set.

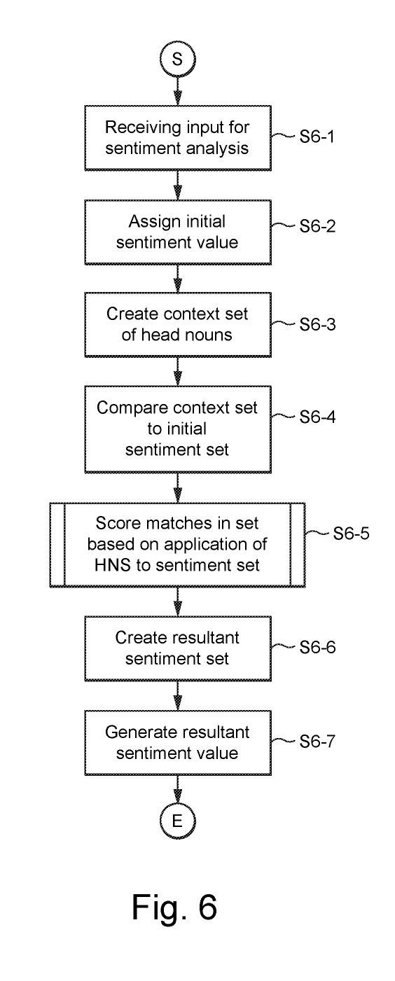

FIG. 6 shows an example application flowchart for determining a resultant sentiment value based on a context set and an initial sentiment set. The processes begins by receiving input for sentiment analysis (S6-1). The input can range from text data, including symbol/character data, to any form of audio/video data (e.g., a YouTube® video). It should be appreciated that in a practical embodiment, audio/video data is converted into text-based input using traditional speech-to-text and/or video-to-text tools.

After receiving the input data, an initial/potential sentiment is assigned to the input data (S6-2). For example, the expressions “I love my iPhone! :),” “I have an iPhone,” and “My iPhone is not working properly” may be assigned with the initial sentiment of positive, neutral, and negative, respectively. Of course, these sentiment values may be associated with numerical values where positive can be +1, neutral can be NULL or 0, and negative can be −1.

After assigning an initial sentiment value to the input data, a context set can be created that contains a head noun structure and dependent terms (S6-3). The context set of head nouns and dependent terms can be formed as a hierarchical structure using a relational table with two or more axes to input a set of naming and descriptive words or phrases as well as their relationships in such a way that the relationship of any term used can be established with respect to any other term in the head noun structure.

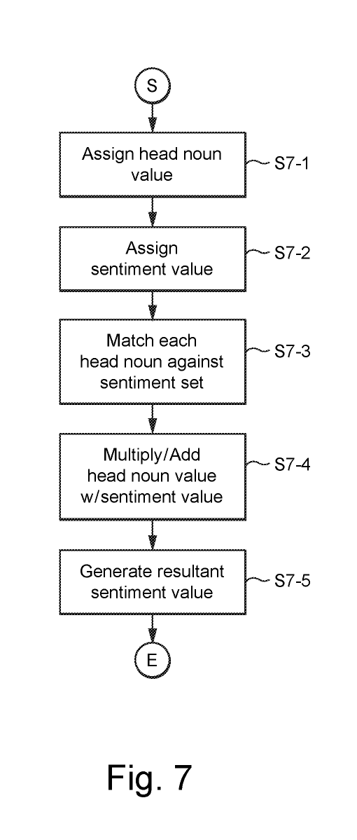

Upon creating the context set containing the head noun structure, the context set can be compared against the initial sentiment set to determine if there are matches between the head noun structure and the initial sentiment set (S6-4). In comparing the context set to the initial sentiment set, the head noun structure is applied to the contents of the initial sentiment set where matches are then scored (S6-5). The further details of assigning values and scoring matches will be discussed with respect to FIG. 7.

After scoring the matches based on the application of the head noun structure to the initial sentiment set, a resultant sentiment set is created (S6-6). The resultant sentiment set can include the input data itself (e.g., text strings) as well as a numerical value (e.g., −1,0,+1) and a descriptive value of the resultant sentiment. After creating the resultant sentiment set, a resultant sentiment value can be generated on the collection of data (S6-7). So for example, if the initial sentiment set contained text strings providing mostly positive reviews for the Apple iPhone®, and the context set is related to Apple, Inc., the overall sentiment value will be generally positive as the viewpoint of Apple, Inc. to positive sentiment on Apple® products is positive. Likewise, if the context set is related to a competitor, such as Sony®, the overall sentiment from the context of Sony® will be generally negative as positive reviews of Apple® products may be generally negative from the viewpoint of Sony®. The resultant sentiment value can be generated by incorporating a numerical bias (e.g., multiplier) in relation to each of the head nouns in the input data and determined from a query (the query typically generated from a chart or by a user) to determine valid head nouns and the priority for ranking them. The results can also be generated “on the fly” by the summing, multiplication, or exclusion of terms from a table of results produced by the analyzer.

FIG. 7 shows an example application flowchart depicting further processes for matching and scoring as discussed with respect to FIG. 6. The process begins by assigning a head noun value to each head noun in the head noun structure (S7-1). This can entail assigning a numerical value to the head noun depending upon the context in which the head noun should be viewed. So for example, a head noun structure having head nouns related to Apple, Inc. products and/or employees (e.g., iPhone®, Macintosh®, Tim Cook) may have positive values assigned to each term if the head noun structure is taken from the context/viewpoint of Apple, Inc. Likewise, each head noun may have a negative value associated with each term if the head noun structure is taken from the context/viewpoint of a competitor, such as Microsoft® or Sony®.

After assigning a head noun value to the head nouns, a sentiment or potential sentiment value can be assigned to each element of the initial sentiment set (S7-2). It should be appreciated that this value can also be assigned to the initial sentiment set prior to creating any head noun structure. That is, potential sentiment values can be determined irrespective of the head noun structure or its respective values.

After assigning the values to the elements in the sentiment set and the elements in the context set, each head noun can be matched against elements in the sentiment set (S7-3). Where there is a match, the head noun structure can be applied against the initial sentiment set via a mathematical operation (e.g., addition/multiplication). For example, an initial sentiment set of positive sentiment for Apple® products will generally have positive numerical values associated with each element (e.g., mostly +1 associated with each element). Then, a context set containing terms relating to Apple, Inc. will match with the sentiment for Apple® products in the sentiment set and the positive values associated with the elements in the Apple head noun structure (e.g., +1) will be multiplied against the values in the sentiment set thus producing many positive values. Likewise, if a head noun structure related to Sony® is applied, many negative values will be produced when applied to an initially positive set of sentiment related to Apple® products.

Once the head nouns are applied against the sentiment set, a resultant sentiment value can be generated (S7-5). This value is generally described as a real, non-integer value that is typically the aggregation of values generated after the application of the head noun structure to the sentiment set. That is, the aggregation of numerical values resulting from applying the head noun structure generates an overall sentiment value. This aggregated value gives a broader spectrum for determining overall sentiment. So statements that provide initial sentiment such as positive, neutral, or negative, can now be described with greater precision. In an example embodiment, by producing a more precise aggregate value, sentiment can vary from very negative, negative, neutral, positive, to very positive. This can be determined, for example, based on a range of numerical values associated with the sentiment expression in a ratio. For example, very negative sentiment for −60% value to sentiment ratio, negative from −60% to −0.2%, neutral from −0.2% to 0.2%, positive from 0.2% to 55% and very positive from greater than 55%. Of course, many variations are available and are not limited to such a list.

While the technology has been described in connection with example embodiments, it is to be understood that the technology is not to be limited to the disclosed embodiments, but on the contrary, is intended to cover various modifications and equivalent arrangements included within the spirit and scope of the appended claims.

1. A system configured to analyze sentiment, comprising:
a transceiver configured to communicate with one or more data sources;
a processor; and
a memory storing computer readable instructions that, when executed by the processor, cause the system to:
receive input data containing one or more expressions in at least text form;
assign a sentiment value to the one or more expressions to create an initial sentiment set including the one or more expressions and the associated sentiment value;
create a context set including a head noun structure, having a plurality of head nouns, and associated dependent terms;
compare the context set against the initial sentiment set to determine matches between the one or more expressions and the plurality of head nouns; and
score the matches in the initial sentiment set and assign polarity to the matches to create a resultant sentiment set including the one or more expressions and the associated score and polarity, the score and polarity having a first value based on a first viewpoint of a first entity, and having a second value, different from the first value, based on a second viewpoint of a second entity.

2. The system of claim 1, wherein the first value based on the first viewpoint is positive relative to the first entity, and the second value based on the second viewpoint is negative relative to the second entity.

3. The system of claim 1, wherein the context set is formed as a hierarchical structure using a relational table having two or more axes.

4. The system of claim 3, wherein the relational table includes at least a root term and one or more dependent terms, where each root term includes an associated relationship between the one or more dependent terms and the root term.

5. The system of claim 1, wherein the resultant sentiment set includes a resultant sentiment value generated by incorporating a numerical bias in relation to each head noun of the plurality of head nouns.

6. The system of claim 1, wherein the input data is received by one or more trawlers that are configured to obtain data from one or more social media web-sites.

7. The system of claim 1, wherein the instructions, when executed by the processor, further cause the system to generate a resultant sentiment value for providing a description of an overall sentiment.

8. A non-transitory computer readable storage medium having computer readable code embodied therein which, when executed by a computer having one or more processors, causes the computer to perform actions comprising:
receiving input data containing one or more expressions;
assigning a sentiment value to the one or more expressions to create an initial sentiment set including the one or more expressions and the associated sentiment value;
creating a context set including a head noun structure having a plurality of head nouns;
comparing the context set against the initial sentiment set to determine matches between the one or more expressions and the plurality of head nouns; and
scoring the matches in the initial sentiment set and assigning polarity to the matches to create a resultant sentiment set, the score and polarity having a first value based on a first viewpoint of a first entity, and having a second value, different from the first value, based on a second viewpoint of a second entity.

9. The non-transitory computer readable storage medium of claim 8, wherein the first value based on the first viewpoint is positive relative to the first entity, and the second value based on the second viewpoint is negative relative to the second entity.

10. The non-transitory computer readable storage medium of claim 8, wherein the context set is formed as a hierarchical structure using a relational table having two or more axes.

11. The non-transitory computer readable storage medium of claim 10, wherein the relational table includes at least a root term and one or more dependent terms, where each root term includes an associated relationship between the one or more dependent terms and the root term.

12. The non-transitory computer readable storage medium of claim 8, wherein the resultant sentiment set includes a resultant sentiment value generated by incorporating a numerical bias in relation to each head noun of the plurality of head nouns.

13. The non-transitory computer readable storage medium of claim 8, wherein the input data is received by one or more trawlers that are configured to obtain data from one or more social media web-sites.

14. A method, comprising:
at an information processing apparatus that includes, at least, a transceiver, a memory, and a processor:
receiving input data containing one or more expressions;
assigning a sentiment value to the one or more expressions to create an initial sentiment set including the one or more expressions and the associated sentiment value;
creating a context set including a head noun structure having a plurality of head nouns;
comparing the context set against the initial sentiment set to determine matches between the one or more expressions and the plurality of head nouns; and
scoring the matches in the initial sentiment set and assigning polarity to the matches to create a resultant sentiment set, the score and polarity having a first value based on a first viewpoint of a first entity.

15. The method of claim 14, wherein the score and polarity have a second value, different from the first value, based on a second viewpoint of a second entity.

16. The method of claim 15, wherein the first value based on the first viewpoint is positive relative to the first entity, and the second value based on the second viewpoint is negative relative to the second entity.

17. The method of claim 14, wherein the context set is formed as a hierarchical structure using a relational table having two or more axes.

18. The method of claim 17, wherein the relational table includes at least a root term and one or more dependent terms, where each root term includes an associated relationship between the one or more dependent terms and the root term.

19. The method of claim 14, wherein the resultant sentiment set includes a resultant sentiment value generated by incorporating a numerical bias in relation to each head noun of the plurality of head nouns.

20. The method of claim 14, wherein the input data is received by one or more trawlers that are configured to obtain data from one or more social media web-sites.
